(19) United States
(12) Patent Application Publication
(10) Pub. No.: US 2005/0145662 A1
(43) Pub. Date: Jul. 7, 2005

(54) EQUIPMENT AND CARGO CARRIER SYSTEMS

(75) Inventors: Marty Williams, Hudson, CO (US); Matthew Drabczyk, Hudson, CO (US)

Correspondence Address: GLENN L. WEBB, P.O BOX 951, CONIFER, CO, 80433, US

(73) Assignee: LET'S GO AERO, INC., Colorado Springs, CO (US)

(21) Appl. No.: 10/906,436

(22) Filed: Feb. 19, 2005

Related U.S. Application Data
(63) Continuation of application No. 09/788,299, filed on Feb. 16, 2001.
(63) Continuation-in-part of application No. 09/336,887, filed on Jun. 18, 1999, now Pat. No. 6,213,539.

(51) Int. Cl. B60R 9/00; B60R 11/00

(52) U.S. Cl. 224/519

(57) ABSTRACT

A carrier system for transporting equipment in a pick-up truck bed. The carrier of a preferred embodiment of the present invention includes an equipment mounting carrier secured to a surface of vehicle. The carrier is capable of having equipment mounting hardware attached to it. The carrier is formed from elongated frames having C channels formed therein for the attachment of equipment mounting hardware.

### RELATED APPLICATIONS

This application is a continuation of Ser. No. 09/788,299, filed Feb. 16, 2001 continuation-in-part of Ser. No. 09/336,887, issued as U.S. Pat. No. 6,213,539.

### FIELD OF THE INVENTION

This invention relates to the field of transporting equipment, and particularly, to systems for transporting sports equipment as well as other equipment.

### BACKGROUND OF THE INVENTION

The use of equipment and cargo is often hindered by the necessity of transporting the equipment and cargo to various locations. One example of this problem is the need to transport bicycles to a desired location, such as a vacation site, tour site, trail site, race, or other locations. Typically this requires either carrying the bicycle in a trunk, bed or backseat of the vehicle or else the use of a carrier of some sort, such as a car top carrier, trunk mounted carrier or receiver mounted carrier.

The use of the interior of the vehicle to transport the equipment creates a number of problems. For instance the lack of available space can be particularly a problem when there are several individuals with their associated equipment involved, especially if there is any significant distance to be traveled. Also, the view of the driver can be easily obstructed by the equipment. There is also a problem associated with damage to the equipment since the vehicle interior is seldom designed to accommodate such equipment. The security of the equipment is also an issue when the vehicle is left unattended, particularly overnight, since it is normally noticeable through the windows of the vehicle.

The use of exterior carriers also have significant problems. Exterior carriers tend to be either the modular component carriers which use racks on the vehicle top, rear or on the receiver, or else the box-type carriers which are essentially cargo boxes mounted on the rooftop. These carriers are cumbersome and create significant aerodynamic problems. The security of such devices are also questionable when the vehicle is left unattended. Also, the equipment is normally uncovered and susceptible to damage from the elements. Another problem with these carriers is the lack of accessibility to the equipment.

None of the prior carriers satisfactorily provided the ease of transporting equipment, the security and the convenience of storage of equipment that is desired. It is therefore desirable to provide such a device that will allow equipment, such as sports equipment as well as other recreational and work equipment, to be easily and securely transported and stored between locations.

### SUMMARY OF THE INVENTION

The present invention accomplishes those needs by providing a system of carriers for transporting equipment between locations. The carriers of the present invention proves a secure and efficient device for transporting such equipment in a secure manner. The carriers of the present invention are relatively inexpensive and is formed of lightweight, high-strength materials.

In a preferred embodiment of the present invention, al frame formed of a slotted channel conduit is mounted to the floor of a compartment or other vehicle surface, such as a pickup bed. This novel use of the slotted channel conduit provides two important functions. First, the frame is mounted to the floor of the compartment directly to provide support to the carrier instead of mounted onto a suspended frame as is commonly done previously. Secondly, equipment mounting hardware can be mounted to the slotted channel conduit to be easily adjusted and interchanged as desired. No other carrier system has this capability.

In an embodiment of the present invention, the carrier system itself is formed from the slotted channel conduit. A frame is formed from this material in a shape that can be directly attached to a roof rack, pick-up bed, or other vehicular surface.

Another preferred embodiment of the present invention utilizes an external frame over the compartment to provide additional securing of equipment, particularly oversize equipment such as kayaks, canoes and the like. The external frame, in a preferred embodiment, is formed from slotted channel conduit members bent to form the exterior frame. Equipment mounting hardware is attached to the slotted channel conduit frame.

In an embodiment, the system utilizes elongated frame members mounted onto surfaces of the vehicle itself. Slots, including C shaped slots, may be formed in the frame members for equipment mounting hardware to be attached thereto.

These and other features of the present invention are evident from the drawings along with the detailed description of preferred embodiments.

### BRIEF DESCRIPTION OF THE DRAWINGS

FIG. 1 is a view of a roof-top carrier version of the carrier system of a preferred embodiment of the present invention.

FIG. 2 is an exploded assembly view of the carrier frame member of the embodiment of FIG. 1.

FIG. 3 is a view of the carrier frame member with equipment mounting hardware secured thereon.

FIG. 4 is a view of the carrier frame member with a bicycle attached thereon.

FIG. 5 is a view of the carrier frame members mounted on a pick-up bed.

FIG. 6 is a view of a trailer embodiment of the carrier frame members.

FIG. 7 is a view of embodiment of FIG. 6 with an oval shaped internal frame.

FIG. 8 is a close-up view of the equipment mounting hardware attached to the internal frame.

FIG. 9 is a close-up exploded view of the carrier frame.

### DETAILED DESCRIPTION OF A PREFERRED EMBODIMENT

Referring in more detail to the drawings, a preferred embodiment of the present invention is described. It is to be expressly understood that this exemplary embodiment is provided for descriptive purposes only and is not meant to unduly limit the scope of the present inventive concept. Other embodiments, and variations of the carriers of the present invention are considered within the present inventive concept as set forth of the claims herein. For explanatory purposes only, the carriers of the preferred embodiments are discussed primarily for use with bicycles. It is to be expressly understood that other types of equipment are contemplated for use with the present invention as well.

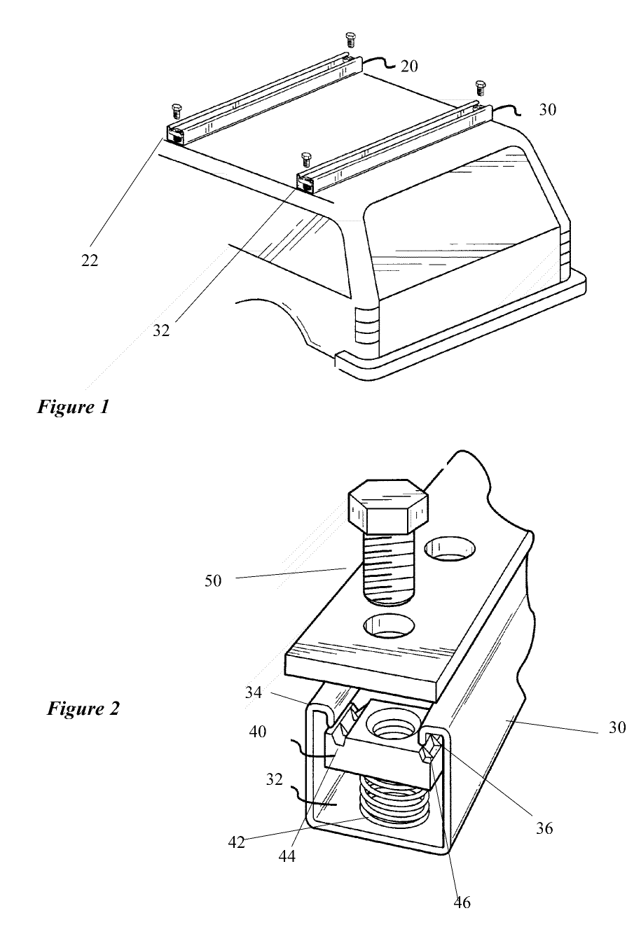

The present invention includes embodiments of carrier systems for equipment and cargo transportation utilizing slotted framing conduit. For instance, the slotted framing conduit may be utilized as a roof-top carrier, as shown in FIG. 1, in lieu of the bars currently widely in use. Appropriate equipment mounting hardware can be easily and adjustable mounted to the slotted framing conduit by threaded fasteners such as spring nuts or other types of fasteners in place of the C-clamps and nuts current used.

A preferred embodiment for equipment transportation is illustrated in FIG. 1. This embodiment includes frame members 20, 30 installed directly onto the surface of a vehicle. These frame members can be directly attached to a roof rack, a pick-up bed, or other vehicular surfaces. For example, the frame members 20, 30 are illustrated installed onto the roof top surface of a sport utility vehicle in FIG. 1. It is to be expressly understood that this illustration is for explanatory purposes only and is not meant to limit the scope of the present invention. These frame members may be installed by bolting directly into the vehicle surface, by adhesives, by straps, by welding or by any other known securing mechanisms. Also, in another preferred embodiment, the frame members may be integrated directly onto the vehicle surface at the time of manufacture of the vehicle or as a later installed accessory. The frame members may also be formed into slots on the vehicle surface.

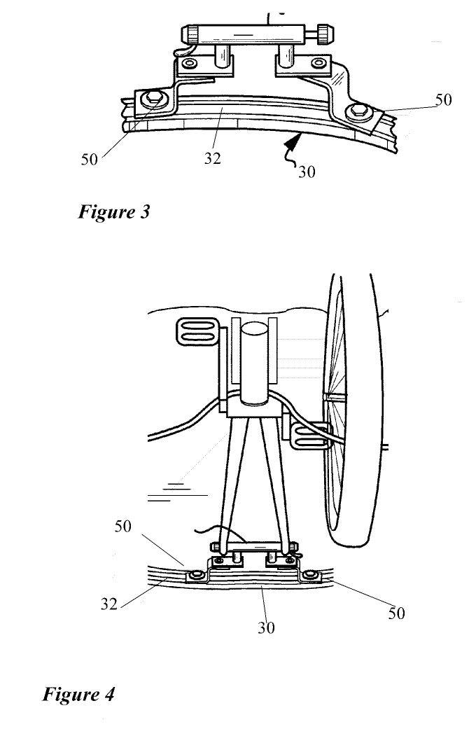

In the preferred embodiment, the frame members include an inverted C shaped channel 22, 32, as more clearly shown in FIG. 2. This C shaped channel may be formed from slotted framing conduit as described in greater detail below. In this preferred embodiment, the channel 32 includes upper lips 34, 36 that extend into the channel 32. Spring nut 40 is inserted into the channel 32 to engage against the upper lips 34, 36. Spring 42 biases the nut 40 upward against those lips. The size of the nut may be selected to prevent the nut from rotating within the channel 32. Also, upper grooves 44, 46 may be provided on the nut to assist in the engagement of the nut against the upper lips. Appropriate equipment mounting hardware can be easily and adjustable mounted to the frame members by bolts 50 engaging the nuts 40. Examples of bicycle mounting hardware secured to the frame members are illustrated in FIGS. 3 and 4.

The frame members may also utilize a non-spring nut system to secure equipment mounting hardware or cleats to the frame members. Adjustable hardware may be mounted by other types of fasteners other than spring nuts, such as non-spring biased nuts, or other adjustable fastening mechanisms. It is to be expressly understood that other types of frame members and engagement mechanisms may be used in lieu of the C shaped channel members and the spring nuts. The frame members may be metallic, plastic or any other structural material. Also, other types of equipment mounting hardware, such as clevis hooks, cargo hooks, other types of sports equipment mounting hardware, equipment mounting hardware, securing fasteners and any other type of hardware may be mounted to the frame members.

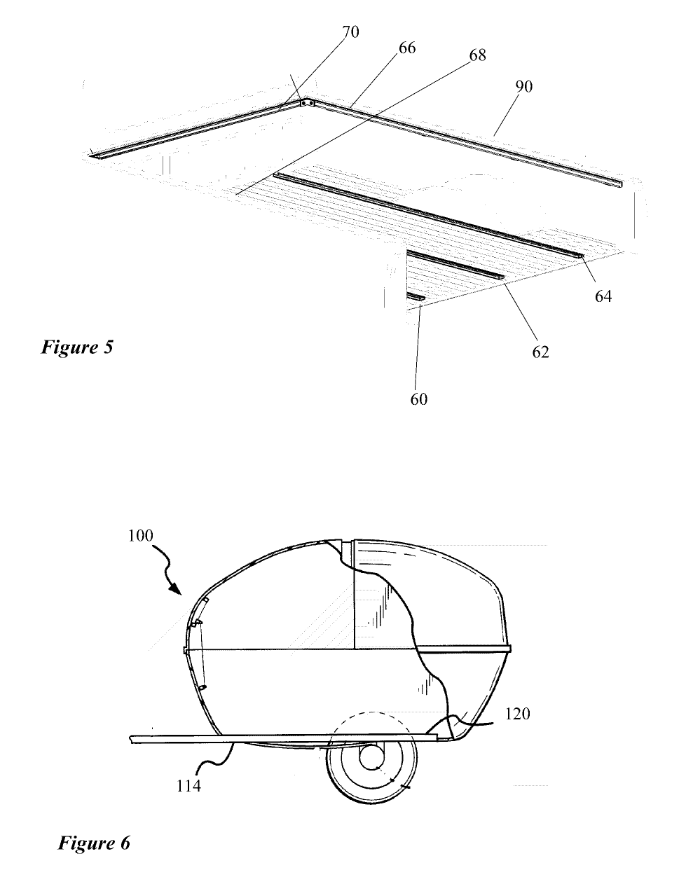

Another example of a preferred embodiment of the present invention is illustrated in FIG. 5. Frame members 60, 62, 64, 66, 68, 70 are mounted on the inner surfaces of the cargo bed 80 of a pickup vehicle. The frame members 60-70 are formed substantially similar to the above described frame members with internal channels or slots and retaining lips. It is again to be expressly understood that other shapes of channels or slots may be used as well.

The frame members 60, 62, 64 are secured on the bottom floor 82 of the cargo compartment 80 of the pickup by bolts, screws, adhesive, welding or other fastening techniques. The frame members may even be formed integrally with the bottom floor. The frame members may extend the full length of the cargo compartment, partial length or even intermittently along the length of the cargo compartment.

Frame members 66, 68, 70 are mounted on the inner side surfaces 84, 86, 88 of the cargo compartment. The typical cargo compartment includes an upper portion 90 on the upper sidewalls of the cargo compartment. These frame members are also fastened to the inner side surfaces of the cargo compartment by well known fastening techniques, including but not limited to bolts, screws, adhesive, welding or other techniques. These frame members may also be formed integrally with the side surfaces. It is also to be expressly understood that the placement and number of frame members may be varied as well.

In a preferred embodiment, the frame members 20, 30, and 60-70 are formed from open-slotted channel conduit 32, such as the slotted conduit provided by Unistrut Corporation. This slotted conduit is used for industrial and commercial applications to provide construction framework as well as electrical cable routing. The present invention provides a unique application for this material. Bicycle mounting hardware 40 is adjustably mounted to the internal frame by spring nuts 30, shown in FIG. 3. The spring nuts 30 are able to slide within the channel 24 of the frame member 20 to the desired spot in the compartment. Thus, the equipment mounting hardware can be quickly interchanged and moved as desired. The spring nuts or other fasteners may be inserted anywhere along the channel 24.

Equipment mounting hardware may be installed in the channels of the frame members as discussed above. The hardware can be adjusted to the desired position and secured at that location. Also the hardware may be removed and replaced with other types of hardware as well. The hardware can include but is not limited to bicycle mounting hardware, kayaks, personal sports craft, or any other type of sports or work related hardware. Cleats, clevis hooks or other types of hardware may also be mounted on the frames to secure cargo as well. Other types of devices may be easily secured by the use of the frame members.

It is to be expressly understood that the above descriptive embodiments are not meant to limit the scope of the claimed inventions. For example, the carrier systems may be installed on any type of vehicle, both on the interior and exterior surfaces. The systems may be installed on the interior surfaces of the cargo compartment of sports utility vehicles, vans, trailers, cars, and other vehicles as well as the exterior surfaces of vehicles including but not limited to roofs, trunk lids, tailgates, hatches, doors and other surfaces of cars, sports utility vehicles, pickups, trucks, trailers, vans, receiver mounted cargo carriers and any other type of surface.

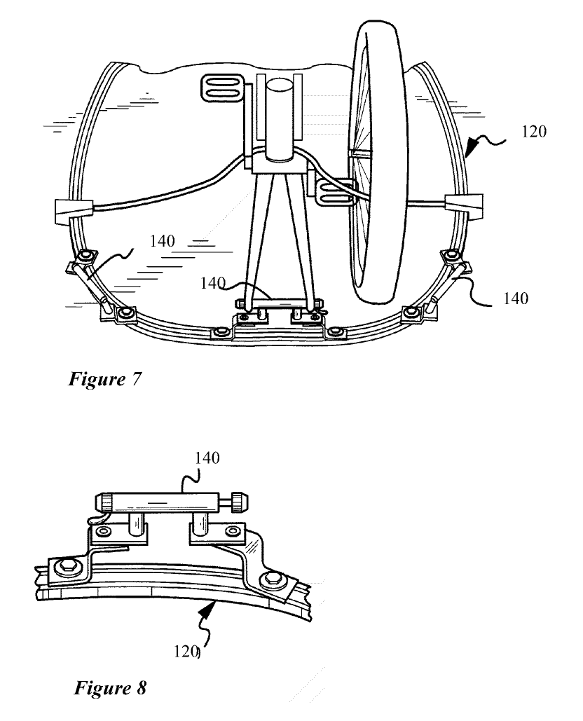

In another preferred embodiment, the present invention provides an aerodynamic trailer that can be easily towed behind most vehicles. The trailer 100, shown in FIGS. 6-9, enables equipment and cargo to be securely and safely stored within the trailer compartment. This trailer is disclosed in greater detail in U.S. patent application Ser. No. 09/788,299, filed by the assignee on Feb. 16, 2001 and incorporated herein by reference. It is to be expressly understood that other types of trailers may be used with this embodiment of the invention.

The present invention of this preferred embodiment provides a unique feature which simultaneously forms the infrastructure of the trailer and provides adjustable hard point mounting for the equipment in the trailer. Trailer 100, shown in FIG. 6, includes internal frame 120 mounted on the floor of the compartment 112. Internal frame 120 is directly mounted to the chassis 114 of the trailer 100 through the floor of the compartment.

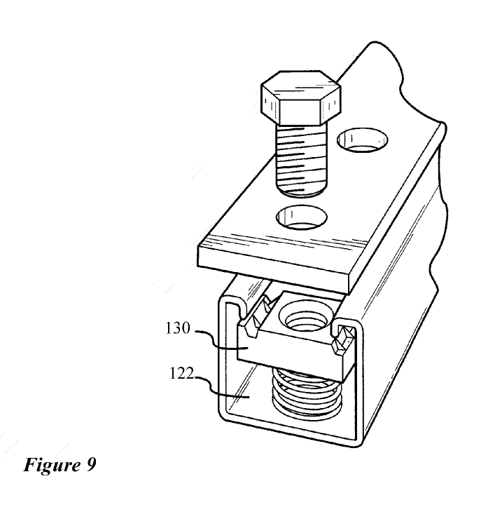

In a preferred embodiment, the internal frame 120 is formed from open-slotted channel conduit 122, such as the slotted conduit provided by Unistrut Corporation. This slotted conduit is used for industrial and commercial applications to provide construction framework as well as electrical cable routing. The present invention provides a unique application for this material. Bicycle mounting hardware 140 is adjustably mounted to the internal frame by spring nuts 130, shown in FIG. 9. The spring nuts 130 are able to slide within the channel 124 of the internal frame 120 to the desired spot in the compartment. Thus, the equipment mounting hardware can be quickly interchanged and moved as desired.

Equipment mounting hardware may be installed in the channels of the frame members as discussed above. The hardware can be adjusted to the desired position and secured at that location. Also the hardware may be removed and replaced with other types of hardware as well. The hardware can include but is not limited to bicycle mounting hardware, kayaks, personal sports craft, or any other type of sports or work related hardware. Cleats, clevis hooks or other types of hardware may also be mounted on the frames to secure cargo as well. Other types of devices may be easily secured by the use of the frame members.

As shown in FIG. 7, internal frame member 120 utilizes this slotted channel conduit bent into a substantially oval shape and mounted on the floor of the compartment directly to the trailer chassis.

The internal frame 120, in one embodiment, includes several points for attaching hardware for securing equipment in the trailer. For example, well-known bicycle securing hardware could be attached for securing bicycle frames within the trailer. Other hardware could be used as well, such as loops or hooks for bungee cords or cargo networks.

The present inventive concept, as set forth in the accompanying claims, covers not only the described embodiments but other embodiments, variations and configurations of the carrier systems as stated in the accompanying claims.

1. A carrier system for transporting equipment and cargo, said carrier system comprising:
a truck bed on a vehicle having at least one carrier surface;
at least one elongated frame member attached on said at least one carrier surface;
a slot having inverted ridges extending into said slot formed in said at least one elongated frame member;
a fastener inserted in said slot engaged against said inverted ridges; and
mounting hardware mounted to said slot on said at least one elongated frame member for securing equipment and cargo in said truck bed.

2. The carrier system of claim 1 wherein said slot includes:
a C shaped slot.

3. The carrier system of claim 1 wherein said slot includes:
a C shaped slot; and
a spring nut contained in said C shaped slot for attaching said equipment mounting hardware to said elongated frame member.

4. The carrier system of claim 1 wherein said mounting hardware includes:
sports equipment mounting hardware.

5. The carrier system of claim 1 wherein said mounting hardware includes:
cargo mounting hardware.

6. The carrier system of claim 1 wherein said mounting hardware includes:
at least one hook for attaching cargo securing devices.

7. The carrier system of claim 1 wherein said mounting hardware includes:
at least one loop for attaching cargo securing devices.
